(19) United States
(12) Patent Application Publication
(10) Pub. No.: US 2023/0066223 A1
(43) Pub. Date: Mar. 2, 2023

(54) FLAGPOLE ADAPTER FOR A GOOSENECK HITCH

(71) Applicant: Mod.al, Draper, UT (US)

(72) Inventors: Preston Ruff, Draper, UT (US); Kreg Peeler, Draper, UT (US)

(21) Appl. No.: 17/409,975

(22) Filed: Aug. 24, 2021

(51) Int. Cl. B62D 63/04; B62D 53/08; G09F 17/00

(52) U.S. Cl. CPC B62D 63/04; B62D 53/08; G09F 17/00; G09F 2017/0075

(57) ABSTRACT

A flagpole adapter for a gooseneck hitch is provided. The flagpole adapter can include a shank that is configured to insert into the receiver of a gooseneck hitch. The flagpole adapter can also include a tube that extends upwardly from the shank and that is configured to receive a flagpole. The flagpole adapter can further include a flagpole securing assembly for securing a flagpole that is inserted into the tube. Because the flagpole adapter is inserted into the receiver of a gooseneck hitch, flags flown using the flagpole adapter will be positioned centrally within the bed of the truck.

### CROSS-REFERENCE TO RELATED APPLICATIONS

N/A

### BACKGROUND

Flags are commonly flown from trucks such as on holidays or for sporting events. A variety of techniques exist for securing a flag to a truck. For example, hitch mounts allow a flagpole to be secured to a hitch but position the flag behind the truck. As another example, clamping mechanisms or permanent attachments could be secured to the wall around the truck's bed and used to secure the flagpole. However, such solutions cause the flag to be positioned at the side of truck.

### BRIEF SUMMARY

The present invention extends to a flagpole adapter for a gooseneck hitch. The flagpole adapter can include a shank that is configured to insert into the receiver of a gooseneck hitch. The flagpole adapter can also include a tube that extends upwardly from the shank and that is configured to receive a flagpole. The flagpole adapter can further include a flagpole securing assembly for securing a flagpole that is inserted into the tube. Because the flagpole adapter is inserted into the receiver of a gooseneck hitch, flag flown using the flagpole adapter will be positioned centrally within the bed of the truck.

In some embodiments, the present invention may be implemented as a flagpole adapter for a gooseneck hitch that includes a shank that is configured to insert into a receiver of a gooseneck hitch, a tube that extends upwardly from the shank and a flagpole securing assembly.

In some embodiments, the shank may include one or more holes for receiving a hitch pin.

In some embodiments, the tube may be axially aligned with the shank.

In some embodiments, the flagpole securing assembly may include a collet.

In some embodiments, the flagpole securing assembly may include a tightening screw. In some embodiments, the tightening screw may include an opening through which a flagpole may be inserted. In some embodiments, the tightening screw may tighten onto a top end of the tube to cause the collet to secure the flagpole.

In some embodiments, the flagpole securing assembly may include a collar that inserts into the tube. In some embodiments, a collet may insert into the collar.

In some embodiments, the flagpole securing assembly may include a jam nut.

In some embodiments, the tube may include threads and a jam nut and tightening screw may also include threads by which the jam nut and tightening screw are secured on the tube.

In some embodiments, the present invention may be implemented as a flagpole adapter for a gooseneck hitch that includes a shank that is configured to insert into a receiver of a gooseneck hitch, a tube having a first end that is secured to the shank and a second end and a flagpole securing assembly at the second end.

In some embodiments, the flagpole securing assembly may include a tightening screw, a collet, a collar and a jam nut.

In some embodiments, the second end of the tube may include threads.

In some embodiments, the collar may insert into the second end of the tube, the collet may insert into the collar and the tightening screw may thread onto the second end to force the collet into the collar to thereby deflect the collet inwardly.

In some embodiments, the jam nut may thread onto the second end before the tightening screw and may be tightened against the tightening screw.

In some embodiments, the flagpole securing assembly may include a collet that is forced into the second end to secure a flagpole inserted through the flagpole securing assembly.

In some embodiments, the present invention may be implemented as a flagpole adapter for a gooseneck hitch that includes a shank that is configured to insert into a receiver of a gooseneck hitch, a tube and a flagpole securing assembly that includes a collet.

In some embodiments, the tube may extend upwardly from the shank and the collet may be positioned at a top end of the tube.

In some embodiments, the flagpole securing assembly may also include a tightening screw that forces the collet into the top end of the tube.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates a pickup truck that has a gooseneck hitch with a turnover ball;

FIG. 2A illustrates a flagpole adapter that is configured in accordance with one or more embodiments of the present invention;

FIG. 2B is an exploded view of the flagpole adapter of FIG. 2A;

FIG. 3A is a closeup view of a flagpole securing assembly of the flagpole adapter of FIG. 2A;

FIG. 3B is an exploded closeup view of the flagpole securing assembly of the flagpole adapter of FIG. 2A;

FIG. 4A is a cross-sectional closeup view of the flagpole securing assembly of the flagpole adapter of FIG. 2A;

FIG. 4B is an exploded cross-sectional closeup view of the flagpole securing assembly of the flagpole adapter of FIG. 2A; and

FIG. 5 illustrates how the flagpole adapter of FIG. 2A can be used to fly a flag from the center of the bed of a truck.

### DETAILED DESCRIPTION

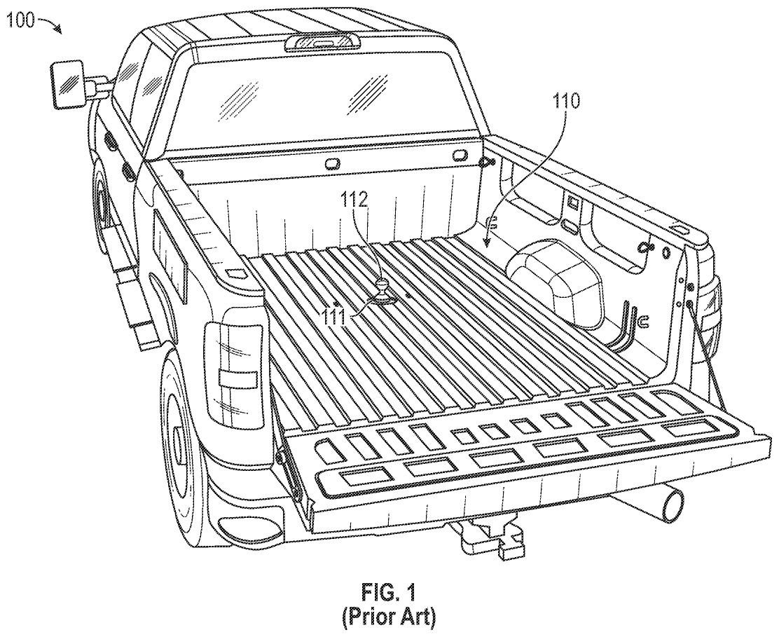

FIG. 1 illustrates a pickup truck 100 having a bed 110 in which a gooseneck hitch 111 has been installed. Gooseneck hitch 111 is commonly installed as an aftermarket component but may be an accessory installed by the pickup truck manufacturer. In FIG. 1, a turnover ball 112 is inserted into gooseneck hitch 111 but may be removed. In accordance with embodiments of the present invention, a flagpole adapter can be used to enable a flag to be secured in bed 110 via gooseneck hitch 111.

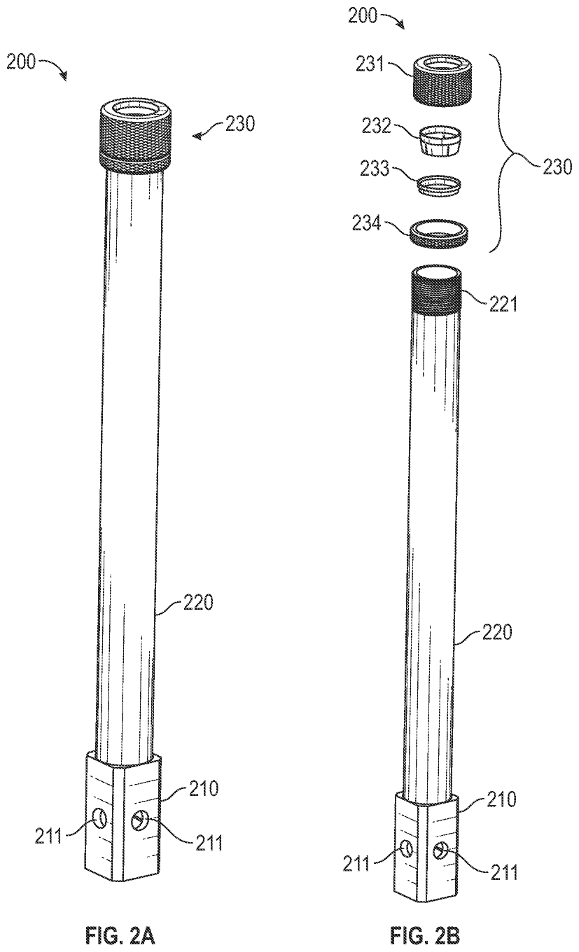

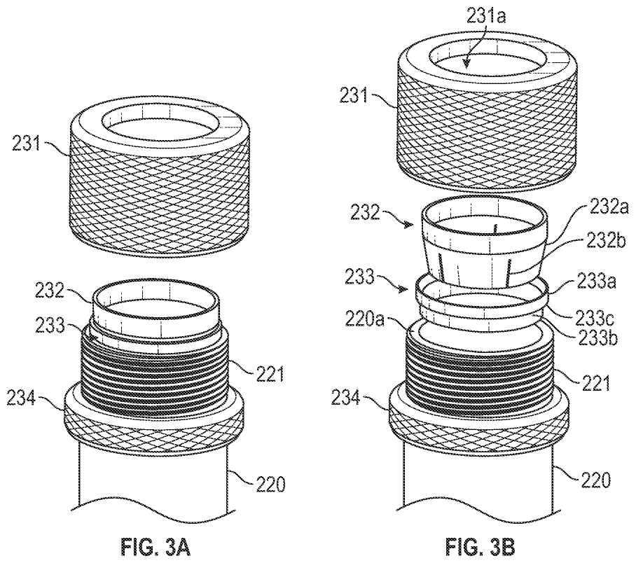

FIGS. 2A-4B are different views of a flagpole adapter 200 that is configured in accordance with one or more embodiments of the present invention. Flagpole adapter 200 includes a shank 210, a tube 220 and a flagpole securing assembly 230.

Shank 210 may be shaped and sized to correspond with the shape and size of the receiver of a gooseneck hitch. For example, a gooseneck hitch may have a 2.5-inch square receiver that uses a turnover ball. In such cases, shank 210 may be substantially square and approximately 2.5 inches wide and 4 inches long to enable it to be inserted into the gooseneck hitch when the turnover ball is removed. However, shank 210 could have any suitable shape and size to enable it to be used with other shaped and/or sized gooseneck hitch receivers.

Shank 210 may also include holes 211 that are sized and positioned to correspond with the size and position of hitch pin holes in the gooseneck hitch receiver. In some embodiments, a hole 211 may be formed in each side of shank 210 to enable shank 210 to be inserted into the gooseneck hitch receiver in any orientation.

Tube 220 may extend upwardly from a top end of shank 210 such that tube 220 is vertically oriented when shank 210 is inserted into a gooseneck hitch receiver. Tube 220 may have any suitable diameter or length for receiving a flagpole. For example, in some embodiments, tube 220 could have a diameter of 1 inch and a length of 2 feet. A bottom end of tube 220 may be welded or otherwise secured to shank 210, and threads 221 may be formed towards a top end 220a of tube 220.

Flagpole securing assembly 230 can be configured to secure a flagpole when the flagpole is inserted into tube 220. In some embodiments, flagpole securing assembly 230 can include a tightening screw 231, a collet 232, a collar 233 and a jam nut 234.

Jam nut 234 can include threads 234a so that it may be secured to tube 220 via threads 221. Jam nut 234 can be threaded onto tube 220 prior to tightening screw 231.

Collar 233 can include an upper portion 233a and a lower portion 233b that has a smaller outer diameter than upper portion 233a such that a downwardly facing lip 233c is formed. Lower portion 233b can insert into tube 220 to cause lip 233c to contact top end 220a of tube 220. In some embodiments, an inside surface of upper portion 233a may be tapered to facilitate insertion of collet 232.

Collet 232 is configured to insert into collar 233 when lower portion 233b of collar 233 is positioned inside tube 220. Collet 232 may include a lower portion 232a that is tapered to facilitate insertion of collet 232 into collar 233.

Tightening screw 231 can include an upward facing opening 231a that enables a flagpole to be inserted through tightening screw 231 and into tube 220. The diameter of opening 231a can be less than an inner diameter of tightening screw 231 so that a downwardly facing lip 231b is formed. Tightening screw 231 can also include threads 231c so that tightening screw 231 can be secured to tube 220 via threads 221.

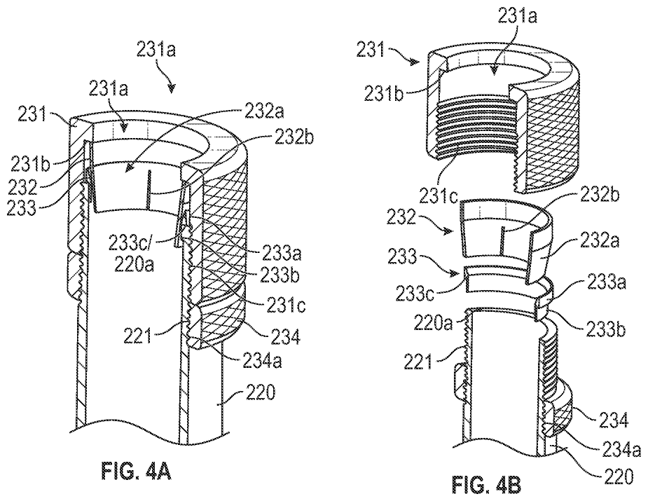

As best seen in FIG. 4A, with jam nut 234 threaded onto tube 220 and with collar 233 and collet 232 inserted into tube 220, tightening screw 231 can be tightened onto tube 220 until lip 23 lb contacts collet 232. Then, as tightening screw 231 is further tightened, lip 23 lb will force collet 232 downwardly into collar 233 which in turn will force lower portion 232a of collet 232 inwardly. Collet 232 may include a number of slits 232b to facilitate this inward deflection of lower portion 232a.

With a flagpole inserted through flagpole securing assembly 230, the inward deflection of lower portion 232a of collet 232 will provide a clamping force on the flagpole to prevent it from being pulled out through opening 231a. Once tightening screw 231 has been tightened to a desired amount onto tube 220, jam nut 234 can be tightened against tightening screw 231 to prevent tightening screw 231 from loosening.

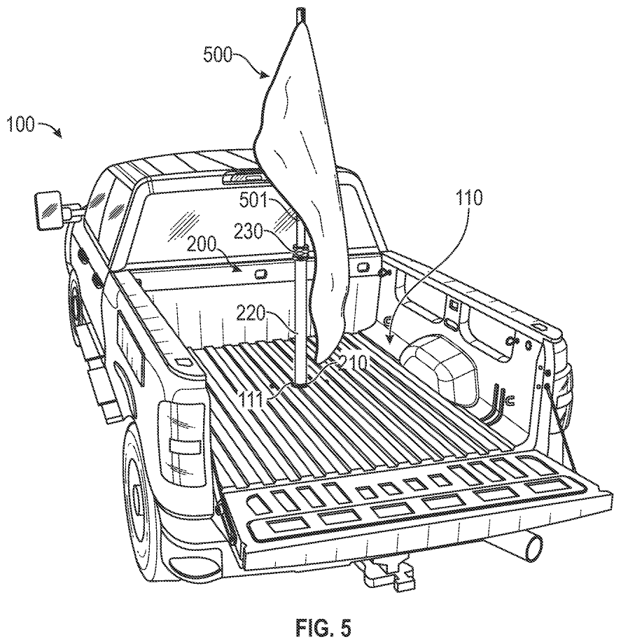

FIG. 5 provides an example of how a flag 500 can be flown from bed 110 of truck 100 using a flagpole 501. In comparison to FIG. 1, turnover ball 112 has been removed from gooseneck hitch 111 and shank 210 of flagpole adapter 200 has been inserted into gooseneck hitch 111. A hitch pin could be inserted through holes 211 to prevent shank 210 from being removed from gooseneck hitch 111.

Because of the positioning of gooseneck hitch 111, flagpole adapter 200 will be positioned vertically and centrally in bed 110. Therefore, when flagpole 501 is inserted into flagpole adapter 200, flag 500 will be positioned centrally within bed 110. Notably, because flagpole adapter 200 uses shank 210 to couple to the receiver of gooseneck hitch 111, it can be quickly and easily attached and removed as desired.

The described embodiments are to be considered in all respects only as illustrative and not restrictive. The scope of the invention is, therefore, indicated by the appended claims rather than by the foregoing description.

What is claimed:

1. A flagpole adapter for a gooseneck hitch comprising:
a shank that is configured to insert into a receiver of a gooseneck hitch;
a tube that extends upwardly from the shank; and
a flagpole securing assembly.

2. The flagpole adapter of claim 1, wherein the shank includes one or more holes for receiving a hitch pin.

3. The flagpole adapter of claim 1, wherein the tube is axially aligned with the shank.

4. The flagpole adapter of claim 1, wherein the flagpole securing assembly includes a collet.

5. The flagpole adapter of claim 4, wherein the flagpole securing assembly includes a tightening screw.

6. The flagpole adapter of claim 5, wherein the tightening screw includes an opening through which a flagpole may be inserted.

7. The flagpole adapter of claim 6, wherein the tightening screw tightens onto a top end of the tube to cause the collet to secure the flagpole.

8. The flagpole adapter of claim 7, wherein the flagpole securing assembly includes a collar that inserts into the tube.

9. The flagpole adapter of claim 8, wherein the collet inserts into the collar.

10. The flagpole adapter of claim 9, wherein the flagpole securing assembly include a jam nut.

11. The flagpole adapter of claim 10, wherein the tube includes threads and the jam nut and tightening screw also include threads by which the jam nut and tightening screw are secured on the tube.

12. A flagpole adapter for a gooseneck hitch comprising:
a shank that is configured to insert into a receiver of a gooseneck hitch;
a tube having a first end that is secured to the shank and a second end; and
a flagpole securing assembly at the second end.

13. The flagpole adapter of claim 12, wherein the flagpole securing assembly includes a tightening screw, a collet, a collar and a jam nut.

14. The flagpole adapter of claim 13, wherein the second end of the tube includes threads.

15. The flagpole adapter of claim 14, wherein the collar inserts into the second end of the tube, the collet inserts into the collar and the tightening screw threads onto the second end to force the collet into the collar to thereby deflect the collet inwardly.

16. The flagpole adapter of claim 15, wherein the jam nut threads onto the second end before the tightening screw and is tightened against the tightening screw.

17. The flagpole adapter of claim 12, wherein the flagpole securing assembly includes a collet that is forced into the second end to secure a flagpole inserted through the flagpole securing assembly.

18. A flagpole adapter for a gooseneck hitch comprising:
a shank that is configured to insert into a receiver of a gooseneck hitch;
a tube; and
a flagpole securing assembly that includes a collet.

19. The flagpole adapter of claim 18, wherein the tube extends upwardly from the shank and the collet is positioned at a top end of the tube.

20. The flagpole adapter of claim 19, wherein the flagpole securing assembly also includes a tightening screw that forces the collet into the top end of the tube.
